(19) United States
(12) Patent Application Publication
(10) Pub. No.: US 2002/0120483 A1
(43) Pub. Date: Aug. 29, 2002

(54) Method for dynamically identifying operation entity and system thereof

(76) Inventor: Chi-Chung Chen, Shin-Tien (TW)

Correspondence Address: BACON & THOMAS, 4th Floor, 625 Slaters Lane, Alexandria, VA, 22314, US

(21) Appl. No.: 09/793,514

(22) Filed: Feb. 27, 2001

(51) Int. Cl. G06F 17/60

(52) U.S. Cl. 705/7

(57) ABSTRACT

Method for dynamically identifying operation entity and system thereof. A query manager serves to dynamically define preset screening conditions such as sort, procedure, schedule, etc. The initial records established in the operation entities are sorted and induced under the screening conditions. A related person via a view manager can connect with a certain screening condition. A view runner automatically opens related operation entity and loads respective records to be processed and meeting the screening conditions. Accordingly, the related person can collectively execute the processing operation of next procedure so as to enhance the efficiency of work flow.

### BACKGROUND OF THE INVENTION

The present invention is related to a method for dynamically identifying operation entity and a system thereof. In work flow, the system is able to identify and screen relevant records and automatically open corresponding operation entity and load respective records to be processed. Accordingly, a related person can collectively execute the processing operation of next procedure so as to enhance the efficiency of work flow.

Conventionally, the control and management of operation entities in a work flow employs a database to first sort and store respective records of the operation entities. Then, with a cooperative program code, a related person via the same system or execution program opens the same operation entity and one by one loads the records with the same sort and property. Then the processing operation of next procedure is executed.

For example, a certain person inputs an order record into a purchase operation system for a superior to approve and sign. The database system will sort and store the records according to the sort of the order. Then, when the related person (superior) actuates the system or execution program, by means of an informing message, the related person can know there is an order in the database to be signed. Then the related person can open the same purchase operation system and load the order record and then sign the order.

In the above control and management of operation entities in a work flow, the work flow of the respective operation entities is set by way of program code. Moreover, the related person must via the same system or execution program opens the same operation entity and one by one loads and signs the records. This leads to great inconvenience in use.

### SUMMARY OF THE INVENTION

It is therefore a primary object of the present invention to provide a method for dynamically identifying operation entity and system thereof. A query manager serves to dynamically define preset screening conditions such as sort, procedure, schedule, etc. The initial records established in the operation entities are sorted and induced under the screening conditions. A related person via a view manager can connect with a certain screening condition. A view runner automatically opens related operation entity and loads respective records to be processed and meeting the screening conditions. Accordingly, the related person can collectively execute the processing operation of next procedure so as to enhance the efficiency of work flow.

The present invention can be best understood through the following description and accompanying drawings wherein:

### BRIEF DESCRIPTION OF THE DRAWINGS

FIG. 1 is a flow chart of the method of the present invention; and

FIGS. 2 is a block diagram of the system of the present invention.

### DETAILED DESCRIPTION OF THE PREFERRED EMBODIMENT

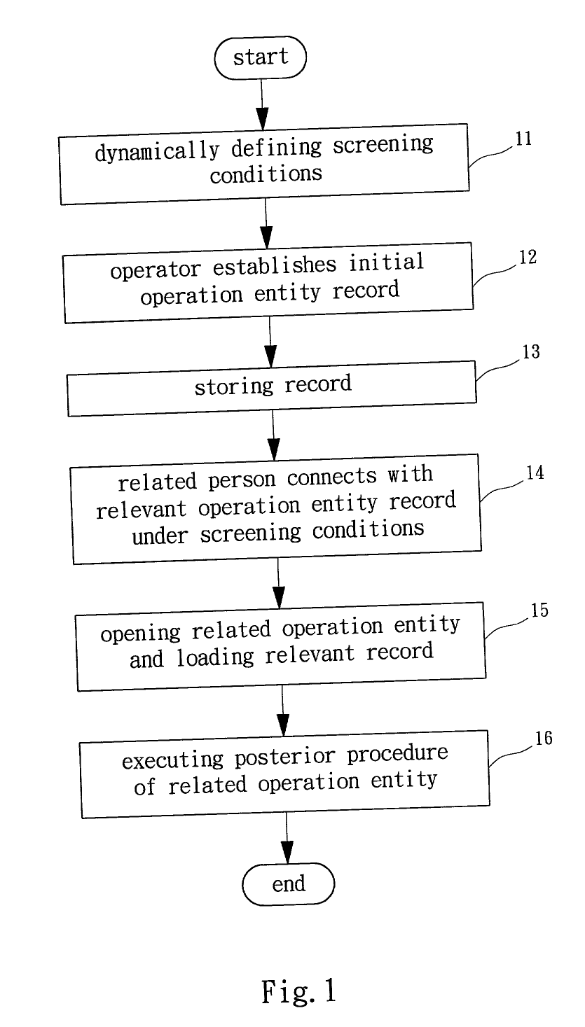

Please refer to FIG. 1 which shows the flow chart of the present invention. The method of the present invention includes steps of “dynamically defining screening conditions” 11 “operator establishes initial operation entity record” 12, “storing record” 13, “related person connects with relevant operation entity record under screening conditions” 14,“opening related operation entity and loading relevant record” 15 and “executing posterior procedure of related operation entity” 16. In step 11 “dynamically defining screening conditions” a user himself can define various kinds of screening conditions and parameters as necessary (such as sort, procedure, schedule, etc.) and give preset screening names. Then, in step 12 “operator establishes initial operation entity record” the user completes input of original records of various kinds of form operation (such as order, informal petition, etc.). The original records are sorted and induced under the screening conditions. In step 13 “storing record”, the records are stored in a database. In step 14 “related person connects with relevant operation entity record under screening conditions”, a related person as set or necessary can directly via the screening name meeting the screening conditions connect with the relevant operation entity records in the database. Then, in step 15 “opening related operation entity and loading relevant record”, the system or execution program automatically executes the same operation entity and loads the initial record established by the operator. Finally, in step 16, the related person executes posterior procedure of related operation entity.

For example, the system or execution program according to actual need or different conditions can define various kinds of orders, invoices, lists, etc. under different screening conditions (including sort, procedure, schedule and other preset conditions) and give preset screening names (such as A1, A2, etc.). After a certain person establishes an original order record in an order operation entity (assumed that the person meets the screening condition defined and named A1), the system or execution program will sort and store the record. In the case that a related person (a superior or an approver of the order) directly executes connection operation of screening name A1, the system or execution program can directly actuate the relevant order operation entity and load the original order record (and all records meeting A1 screening conditions). Therefore, the related person can be conveniently sign or execute the processing operation of next procedure.

The above initial operation entity records are identified by means of the screening conditions. In the case that the screening condition excludes record (list) serial number, numerous different records pertaining to the same screening condition to be processed can be collected for the related person to process at one time. This enhances the working efficiency.

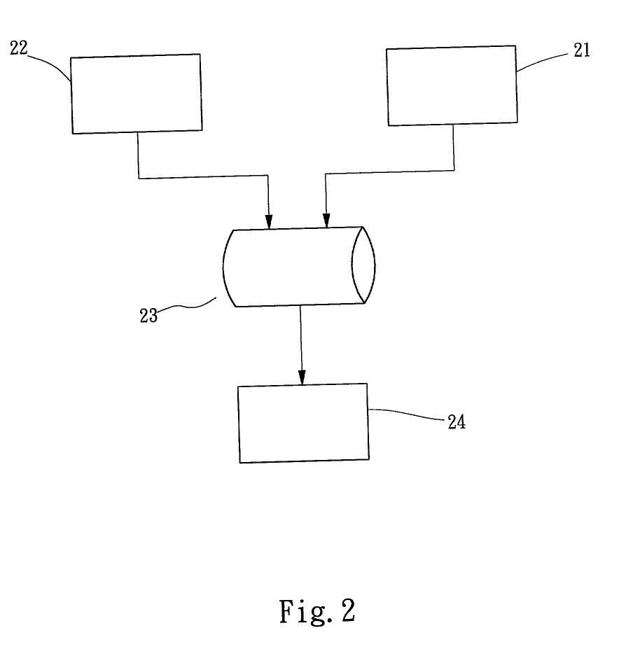

FIG. 2 is a system block diagram according to FIG. 1. The system of the present invention includes a query manager 21, a view manager 22 and a view runner 24 respectively connected with the database 23. The query manager 21 serves to execute the step 11 “dynamically defining screening conditions”. The defined screening conditions are given preset names and stored in the database 23. The view manager 22 serves to execute the step 14 “related person connects with relevant operation entity record under screening conditions”. The view runner 34 serves to execute the step 15 “opening related operation entity and loading relevant record”.

The above embodiment is only used to illustrate the present invention, not intended to limit the scope thereof. Many modifications of the above embodiment can be made without departing from the spirit of the present invention.

What is claimed is:

1. Method for dynamically identifying operation entity, comprising steps of:
“dynamically defining screening conditions” in which a user himself can define various kinds of screening conditions and parameters as necessary, the initial records established in the operation entities being sorted and induced under the screening conditions;
“related person connects with relevant operation entity record under screening conditions” in which a related person as necessary under the screening conditions connects with the initial operation entity records established by the operator; and
“opening related operation entity and loading relevant record” in which the system or execution program executes the same operation entity and loads all the initial records meeting the screening conditions, whereby the related person can execute relevant posterior procedure.

2. Method for dynamically identifying operation entity as claimed in claim 1, wherein the defined screening conditions and initial operation entity records established by the operator can be stored in a step of storing record.

3. Method for dynamically identifying operation entity as claimed in claim 1, wherein the dynamically defined screening conditions are respectively given preset screening names.

4. System for dynamically identifying operation entity, comprising:
a query manager for defining screening conditions;
a view manager for connecting with relevant operation entity records under screening conditions; and
a view runner for executing the operation entity of the same system or execution program and loading the initial records established by the operator.

5. System for dynamically identifying operation entity as claimed in claim 4, wherein the defined screening conditions and initial operation entity records established by the operator are stored in a database.
